(19) United States
(12) Patent Application Publication
(10) Pub. No.: US 2014/0002230 A1
(43) Pub. Date: Jan. 2, 2014

(54) POWER TRANSFORMER

(71) Applicants: Ching Chieh Hsiao, Milpitas, CA (US); Zhi An Xiong, Shenzhen (CN)

(72) Inventors: Ching Chieh Hsiao, Milpitas, CA (US); Zhi An Xiong, Shenzhen (CN)

(73) Assignee: WURTH ELECTRONICS MIDCOM, INC., Watertown, SD (US)

(21) Appl. No.: 13/978,026

(22) PCT Filed: Jan. 6, 2012
(86) PCT No.: PCT/CN2012/070108

§ 371 Date: Sep. 19, 2013

(30) Foreign Application Priority Data
Jan. 7, 2011 (CN) 201110002714.2

(51) Int. Cl. H01F 38/10; H01F 27/255

(52) U.S. Cl. CPC H01F 38/10; H01F 27/255
USPC 336/212

(57) ABSTRACT

A transformer core portion (110) for a power transformer (100) housed within a cylinder shaped light fixture is provided. The power transformer (100) includes a transformer core portion (110) that includes the first and the second core portions (115). Each of the first and second core portions (115) includes an approximately half-cylinder shaped top surface (117) and an interior space for housing a wire wound bobbin. The power transformer also includes a bobbin base (120) housed within the first and second core portions (115).

### CROSS REFERENCE TO RELATED APPLICATION

This application is being filed as a PCT International Application in the name of Wurth Electronics Midcom, Inc. and claims the benefit of Chinese Patent Application No. 201110002714.2, filed Jan. 7, 20111, entitled ‘Transformer Core’.

### FIELD

This disclosure relates to the field of electrical transformers. More particularly, this description relates to a power transformer that can be housed within a cylindrical tube.

### BACKGROUND

Use of high voltage power transformers in conventional fluorescent tube light fixtures is known. Typically standard T8 LED tube lights use standard EE style power transformers to provide the necessary voltage to light the fixture.

FIGS. 5A and 5B provide a cross-sectional view and a side view of a power transformer 500 housed within a conventional EE style power transformer core 505 disposed on a printed circuit board (PCB) within a cylindrical tube 605 of a light fixture. In this embodiment, the tube 605 is a cylindrically shaped T8 tube. As shown in FIGS. 5A and 5B, the shape of the conventional power transformer 500 is not capable of maximizing the space available in the tube 605, thereby limiting the power handling characteristics of the power transformer 500.

### SUMMARY

This application describes a power transformer. Particularly, the embodiments provided herein are directed to a power transformer that can be housed within a cylindrical tube.

The embodiments herein provide a transformer core portion that is able to maximize the available volume inside a cylindrical tube for maximized power handling characteristics. In particular, the transformer core portion is tooled to an approximately half-cylinder shaped structure in order to use the maximum amount of space available within, for example, a light tube to fit a power transformer. In some embodiments, the transformer core portion is tooled to an approximate half-cylinder shaped structure in order to use the maximum amount of space available within a T8 light tube.

Accordingly, in one embodiment, a power transformer for a light fixture is provided. The power transformer includes a transformer core portion that includes first and second core portions. Each of the first and second core portions include an approximately half-cylinder shaped top surface and an interior space for housing a wire wound bobbin. The power transformer also includes a bobbin base housed within the first and second core portions.

In some embodiments, the transformer core portion is composed of magnetic ferrite.

In some embodiments, the transformer core portion is sized to fit into a tube-shaped light fixture.

In some embodiments, the transformer core portion is sized to fit into a T8 tube-shaped light fixture.

In some embodiments, the bobbin base includes a bobbin rail at opposite ends of the bobbin base, each bobbin rail including one or more pins for electrically connecting a wire housed within the transformer core portion to a printed circuit board.

In some embodiments, the half-cylinder shaped top surface is sized to use a maximum amount of space available within the cylinder shaped light fixture.

In some embodiments, winding channels are formed between a bottom surface of the first and second core portions and a bottom surface of the bobbin base that access an interior space of the transformer core portion for allowing a winding wire to wind around the top surface and the bottom surface of the bobbin base.

In some embodiments, the first and second core portions each include an approximately half-cylinder shaped projection extending, within the interior space, from a first end surface of the first or second core portion to approximately a second end of the first or second core portion.

In some embodiments, the bobbin base includes an approximately half-cylinder shaped top surface, an approximately half-ring shaped side surface, and an approximately flat bottom surface.

In some embodiments, the top surface and the bottom surface of the bobbin base define a hollow interior with openings formed at opposite ends of the bobbin base.

In some embodiments, the openings allow the projection of the transformer core portion to slide into the hollow interior.

In some embodiments, the transformer core portion is sized with a flat top surface portion to allow for pick and place soldering operations.

### DRAWINGS

FIG. 1A is a top perspective view of a power transformer, according to one embodiment.

FIG. 1B is a bottom perspective view of a power transformer, according to one embodiment.

FIG. 1C is a top view of a power transformer, according to one embodiment.

FIG. 1D is a bottom view of a power transformer, according to one embodiment.

FIG. 1E is an end view of a power transformer, according to one embodiment.

FIG. 2A is a top perspective view of a transformer core portion for a power transformer, according to one embodiment.

FIG. 2B is a bottom perspective view of a transformer core portion for a power transformer, according to one embodiment.

FIG. 2C is a bottom view of a transformer core portion for a power transformer, according to one embodiment.

FIG. 2D is an end view of a transformer core portion for a power transformer, according to one embodiment.

FIG. 3A is a top perspective view of a bobbin base for a power transformer, according to one embodiment.

FIG. 3B is a bottom view of a bobbin base for a power transformer, according to one embodiment.

FIG. 3C is a side view of a bobbin base for a power transformer, according to one embodiment.

FIG. 3D is an end view of a bobbin base for a power transformer, according to one embodiment.

FIG. 4A is a cross-sectional view of a power transformer housed within a cylindrically shaped light fixture, according to one embodiment.

FIG. 4B is a side view of a power transformer housed within a cylindrically shaped light fixture, according to one embodiment.

FIG. 5A is a cross-sectional view of a conventional EE style power transformer within a cylindrically shaped light fixture.

FIG. 5B is a side view of a conventional EE style power transformer within a cylindrically shaped light fixture.

FIG. 6 is a top perspective view of a power transformer, according to another embodiment.

### DETAILED DESCRIPTION

The embodiments provided herein are directed to a power transformer. Particularly, the embodiments herein provide a power transformer housed within a cylindrical tube.

The embodiments herein provide a power transformer that is able to maximize the available volume inside a cylindrical tube for maximized power handling characteristics. In particular, the power transformer is formed with an approximately half-cylinder shaped structure in order to use the maximum amount of space available for a wire-wound bobbin to fit within a transformer core portion of the power transformer.

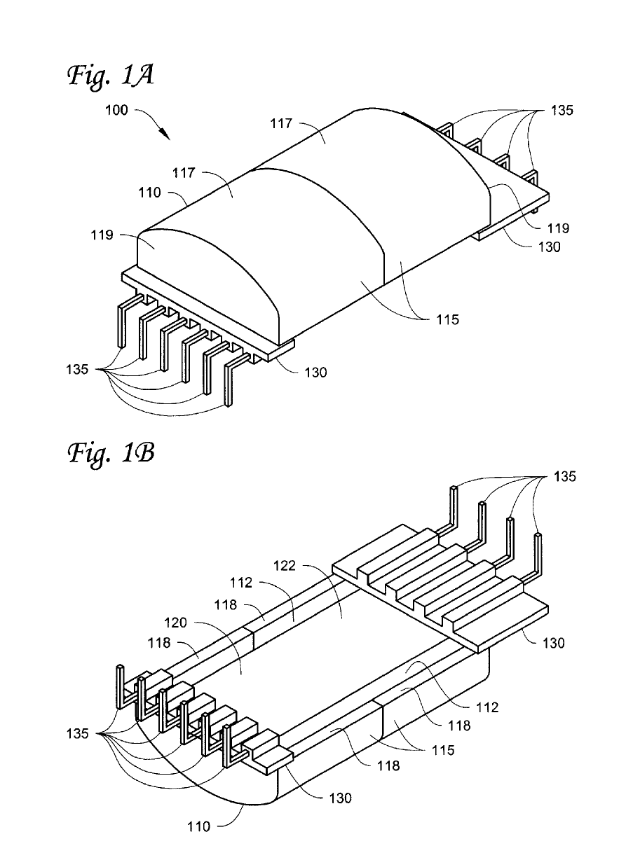

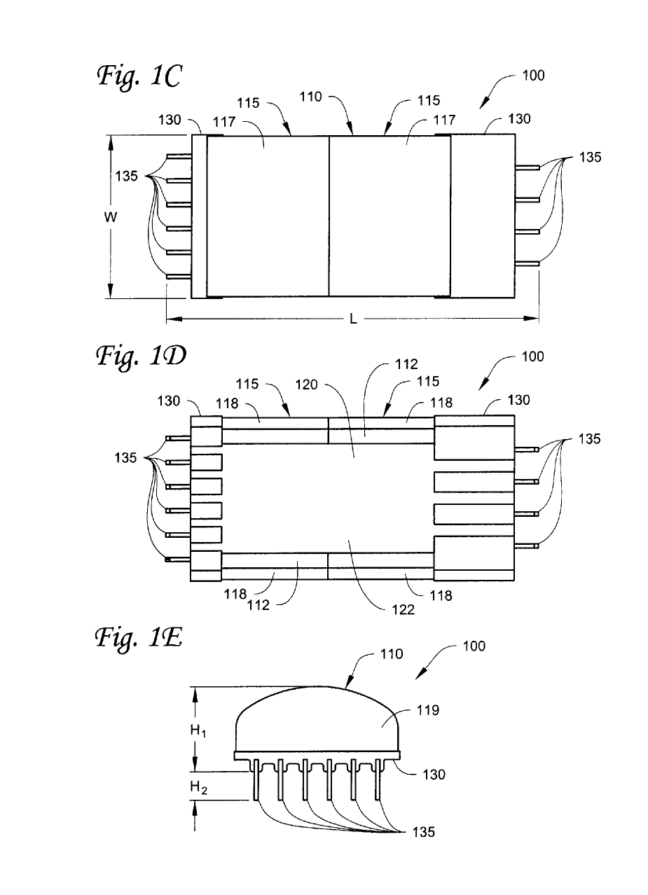

FIGS. 1A-E show different views of a power transformer 100, according to one embodiment. The power transformer 100 includes a transformer core portion 110 and a bobbin base 120 (shown in FIG. 1B). In this embodiment, the transformer core portion 110 is a magnetic ferrite core composed of manganese-zinc (MgZn) raw materials. As shown in FIG. 1A, the transformer core portion 110 is made up of two core portions 115 (i.e. first and second core portions). Each of the core portions 115 includes an approximate half-cylinder shaped top surface 117 and an approximate half-circle shaped end surface 119. As shown in FIG. 1B, winding channels 112 are formed between a bottom surface 118 of the core portions 115 and a bottom surface 122 of the bobbin base 120 that access an interior space of the transformer core portion 110 for allowing a winding wire to wind around a bobbin (not shown). Also, in some embodiments, the bottom surface 122 is flat.

The bobbin base 120 includes a bobbin rail 130 at opposite ends of the bobbin base 120. The bobbin rails 130 include angled pins 135 that extend downwardly from the bobbin rails 130 for electrically connecting a winding wire of the power transformer to a PCB (not shown).

The power transformer 100 is designed to be disposed on a PCB (not shown) and housed within a cylindrical tube. In this embodiment, the shape of the power transformer 100 is configured to be housed within a standard cylindrical T8 light fixture tube. In this embodiment, the maximum length L of the power transformer 100 from the pins 135 at one end to the pins 135 at the opposite end is approximately 45.72 mm (see FIG. 1C). Also, the maximum width W between opposite sides of the power transformer 100 is approximately 22.5 mm (see FIG. 1C). The maximum height H₁ of the power transformer 100 from the bottom of the bobbin rails 130 of the bobbin base 120 to the highest point of the top surface 117 is approximately 12 mm (see FIG. 1E). Also, at one end of the power transformer 100, the height H₂ of the pins 135 is approximately 3 mm (see FIG. 1E) and the height of the pins 135 at the opposite end of the power transformer 100 is approximately 4 mm (not shown). In other embodiments, the shape and measurements of the power transformer 100 can be configured to be housed within, e.g., a T10 light fixture tube, T12 light fixture tube, etc.

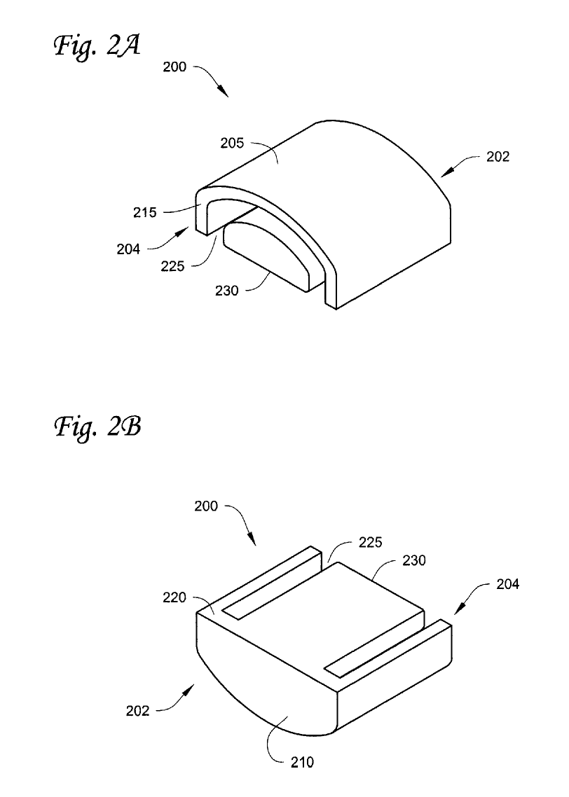

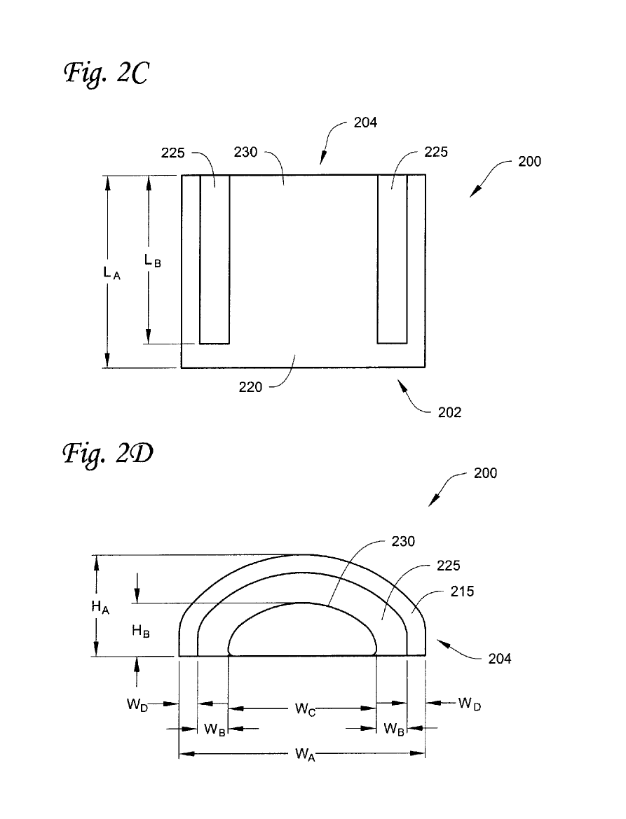

FIGS. 2A-D show different views, respectively, of a transformer core portion 200 for a power transformer, such as the power transformer 100 shown in FIGS. 1A-E, according to one embodiment. The transformer core portion 200 includes an approximately half-cylinder shaped top surface 205, an approximately half-circle shaped first end surface 210 at a first end 202 of the transformer core portion 200, and an approximately half-ring shaped second end surface 215 at a second end 204 of the transformer core portion 200, and a bottom surface 220. The transformer core portion 200 also includes an approximately half-cylinder shaped projection 230 extending, within an interior space 225 of the transformer core portion 200, from the first end surface 210 to approximately the second end 204. The projection 230 is designed to fit within a barrel opening of a bobbin base (not shown) of a power transformer, such as the bobbin base 120 of the power transformer 100. The interior space 225 of the transformer core portion 200 is designed in order to maximize the amount of space available for a bobbin base (not shown) within the power transformer.

In this embodiment, the shape of the transformer core portion 200 is configured for a power transformer core portion is to be housed within a standard cylindrical T8 light fixture tube, such as the power transformer 100 shown in FIGS. 1A-E. In this embodiment, the maximum length L_{A} from the first end 202 to the second end 204 of the transformer core portion 200 is approximately 17.2 mm and the maximum length L_{B} of the interior space 225 within the transformer core portion 200 is approximately 14.2 mm (see FIG. 2C). As shown in FIG. 2D, the maximum height H_{A} of the transformer core portion 200 is approximately 8.4 mm and the maximum height H_{B} of the projection 230 is approximately 4.4 mm. Also, the maximum width W_{A} of the transformer core portion 200 is approximately 20.3 mm, the width W_{B} of the interior space near the bottom surface 220 is approximately 2.5 mm, the maximum width W_{C} of the projection 230 at the second end 204 is approximately 12.2 mm, and the width W_{D} of the first end surface 210 near the bottom surface 220 is approximately 1.55 mm. In other embodiments, the shape and measurements of the transformer core portion 200 can be configured for a power transformer to be housed within, e.g., a T10 light fixture tube, T12 light fixture tube, etc.

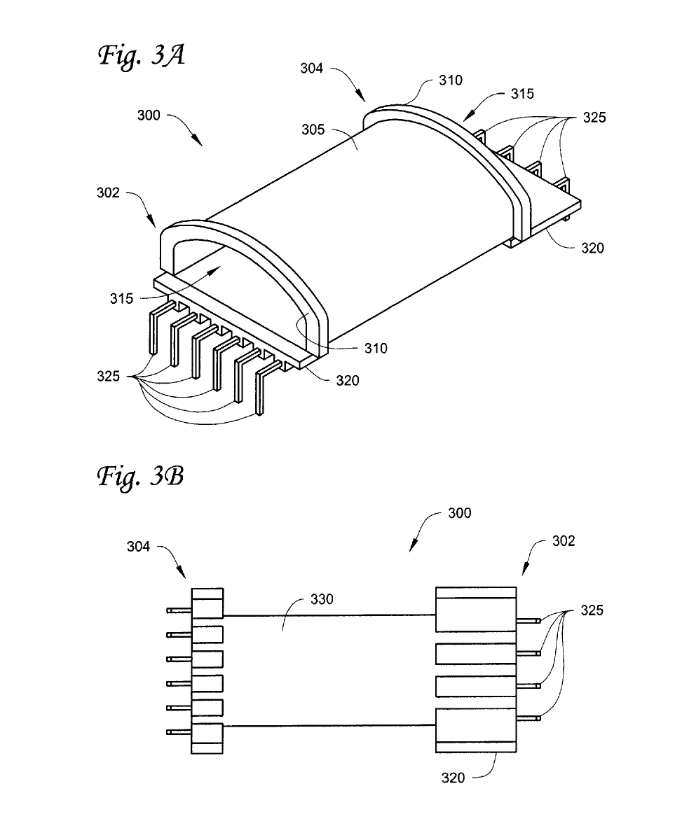

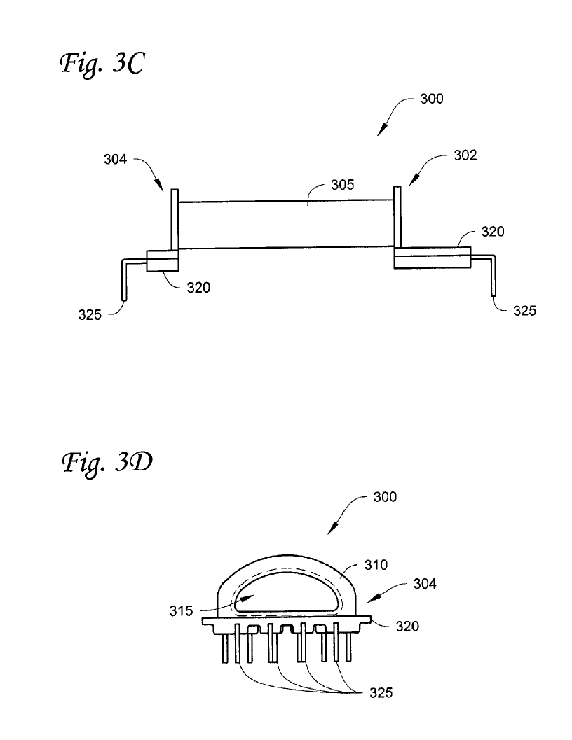

FIGS. 3A-D provide different views of a bobbin base 300 for a power transformer, according to one embodiment. The bobbin base 300 includes an approximately half-cylinder shaped top surface 305, an approximately half-ring shaped side surface 310 at each end of the bobbin base 300, and an approximately flat bottom surface 330 (see FIG. 3B). The top surface 305 and the bottom surface 330 of the bobbin base 300 define a hollow interior with barrel openings 315 formed at opposite ends 302, 304 of the bobbin base 300. The barrel openings 315 are designed to be the same shape as a projection of a transformer core portion (such as the projection 230 of the transformer core portion 200) so as to allow the projection of the transformer core portion to slide into the hollow interior, thereby attaching the bobbin base 300 to a transformer core portion at each of the opposite ends 302, 304. Also, a pair of pin rails 320 with pins 325 are attached to opposite ends of the bottom surface 330 of the bobbin base 300 (see FIGS. 3B and 3C), near the opposite ends 302, 304.

In this embodiment, the shape of the bobbin base 300 is configured for a power transformer that is to be housed within a standard cylindrical T8 light fixture tube, such as the power transformer 100 shown in FIGS. 1A-E, and to allow a transformer core portion to attach to opposite ends 302, 304 of the bobbin base 300, such as the transformer core portion 200 shown in FIGS. 2A-D. That is, the barrel openings 315 are sized to allow the projection 230 of the transformer core portion 200 to slide into the hollow interior of the bobbin base 300 and allow the second end surface 215 of the transformer core portion 200 to slide over side surface 310 of the bobbin base 300. In other embodiments, the shape and measurements of the bobbin base 300 can be configured for a power transformer to be housed within, e.g., a T10 light fixture tube, T12 light fixture tube, etc.

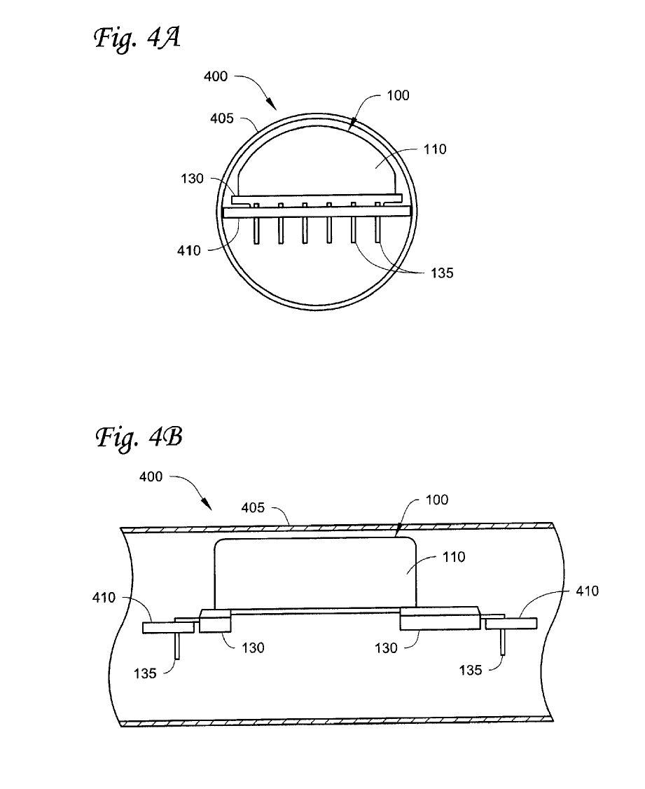

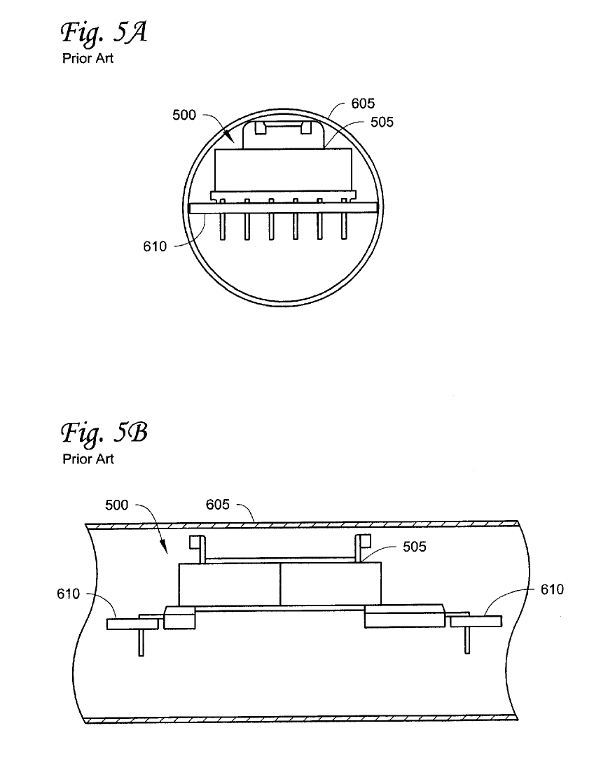

FIGS. 4A and 4B show a cross-sectional view and a side view of the power transformer 100 (shown in FIGS. 1A and 1B) housed within a cylindrically shaped light fixture 400, according to one embodiment. The light fixture 400 includes a tube 405 and a PCB 410 housed within the tube 405.

In this embodiment, the tube 405 is a cylindrically shaped T8 tube. In other embodiments, the tube 405 can be any sized tube, including, for example, a T10 or a T12 tube.

As shown in FIGS. 4A and 4B, the power transformer 100, and particularly the core housing 110, is shaped to use the maximum space available in the tube 405. For power transformers, the volumetric size of the transformer core portion has a direct impact on power handling. With all else being equal, a larger mass transformer core portion will result in a power transformer with higher power handling characteristics. Thus, as opposed to a standard EE style power transformer (as shown in FIGS. 5A and 5B), the power transformer 100 is designed to utilize all available area within the tube 405 in order to maximize the power handling characteristics.

The power transformer 100 is disposed on the PCB 410 such that the bobbin rails 130 are adjacent to the PCB 410 and the pins 135 are connected to the PCB 410.

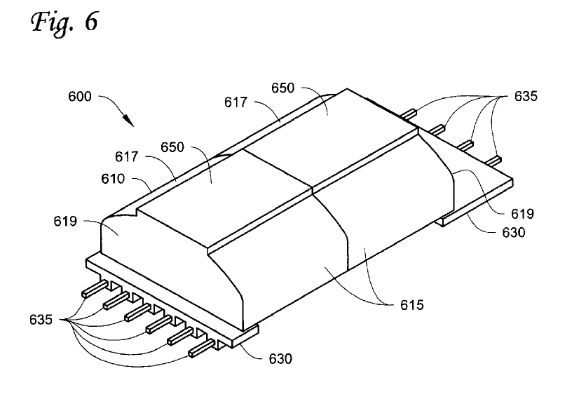

FIG. 6 shows a top perspective view of a power transformer 600, according to another embodiment. The power transformer 600 is similar to the power transformer 100 shown in FIGS. 1A-1E and includes a transformer core portion 610 and a bobbin base (not shown). The transformer core portion 610 is a magnetic ferrite core composed of manganese-zinc (MgZn) raw materials.

As shown in FIG. 6, the transformer core portion 610 is made up of two core portions 615 (i.e. first and second core portions). Each of the core portions 615 includes an approximate half-cylinder shaped top surface portion 617, a flat top surface portion 650 and an approximate half-circle shaped end surface 619. The flat top surface portion 650 provides a flat surface to allow for pick and place soldering operations on the power transformer 600.

Winding channels, such as the winding channels 112, can be formed between a bottom surface of the core portions 615 and a bottom surface of the bobbin base that access an interior space of the transformer core portion 610 for allowing a winding wire to wind around a bobbin (not shown). Also, in some embodiments, the bottom surface can be flat.

The bobbin base includes a bobbin rail 630 at opposite ends of the bobbin base. The bobbin rails 630 include straight pins 635 that extend in an approximately straight direction from the bobbin rails 630 for electrically connecting a winding wire of the power transformer to a PCB (not shown).

The power transformer 600 is designed to be disposed on a PCB (not shown) and housed within a cylindrical tube. In this embodiment, the shape of the power transformer 600 is configured to be housed within a standard cylindrical T8 light fixture tube. In this embodiment, the maximum length L of the power transformer 600 from the pins 635 at one end to the pins 635 at the opposite end is approximately 36.50 mm. Also, the maximum width W between opposite sides of the power transformer 600 is approximately 18.8 mm. The maximum height H₁ of the transformer core portion 600 from the bottom of the bobbin rails 630 of the bobbin base to the highest point, e.g., the flat top surface portion 650, is approximately 12 mm. In other embodiments, the shape and measurements of the power transformer 600 can be configured to be housed within, e.g., a T10 light fixture tube, T12 light fixture tube, etc.

### ASPECTS

1. A power transformer for a light fixture, comprising:
a transformer core portion that includes first and second core portions, each of the first and second core portions including an approximately half-cylinder shaped top surface and an interior space for housing a wire wound bobbin; and
a bobbin base housed within the first and second core portions.

2. The power transformer of aspect 1, wherein the transformer core portion is composed of a magnetic ferrite.

3. The power transformer of any of aspects 1-2, wherein the transformer core portion is sized to fit into a tube-shaped light fixture.

4. The power transformer of any of aspects 1-3, wherein the tube-shaped light fixture is a T8 light fixture tube.

5. The power transformer of any of aspects 3-4, wherein the half-cylinder shaped top surface is sized to use a maximum amount of space available within the tube-shaped light fixture.

6. The power transformer of any of aspects 1-5, wherein the bobbin base includes a bobbin rail at opposite ends of the bobbin base, each bobbin rail including one or more pins for electrically connecting a wire housed within the transformer core portion to a printed circuit board.

7. The power transformer of any of aspects 1-6, wherein winding channels are formed between the first core portion and the second core portion and a bottom surface of the bobbin base that access an interior space of the transformer core portion for allowing a winding wire to wind around the bobbin base.

8. The power transformer of any of aspects 1-7, wherein the first and second core portions each include an approximately half-cylinder shaped projection extending, within the interior space, from a first end surface of the first or second core portion to approximately a second end of the first or second core portion.

9. The power transformer of any of aspects 1-8, wherein the bobbin base includes an approximately half-cylinder shaped top surface, an approximately half-ring shaped side surface at each of the bobbin base, and an approximately flat bottom surface.

10. The power transformer of aspect 9, wherein the top surface and the bottom surface of the bobbin base define a hollow interior with openings formed at opposite ends of the bobbin base.

11. The power transformer of aspect 10, wherein the openings allow the projection of the first and second core portions to slide into the hollow interior.

12. The power transformer of any of aspects 1-11, wherein the transformer core portion is sized with a flat top surface configured for pick and place soldering operations.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A power transformer for a light fixture, comprising:
a transformer core portion that includes first and second core portions, each of the first and second core portions including an approximately half-cylinder shaped top surface and an interior space for housing a wire wound bobbin; and
a bobbin base housed within the first and second core portions.

2. The power transformer of claim 1, wherein the transformer core portion is composed of a magnetic ferrite.

3. The power transformer of claim 1, wherein the transformer core portion is sized to fit into a tube-shaped light fixture.

4. The power transformer of claim 1, wherein the tube-shaped light fixture is a T8 light fixture tube.

5. The power transformer of claim 3, wherein the half-cylinder shaped top surface is sized to use a maximum amount of space available within the tube-shaped light fixture.

6. The power transformer of claim 1, wherein the bobbin base includes a bobbin rail at opposite ends of the bobbin base, each bobbin rail including one or more pins for electrically connecting a wire housed within the transformer core portion to a printed circuit board.

7. The power transformer of claim 1, wherein winding channels are formed between the first core portion and the second core portion and a bottom surface of the bobbin base that access an interior space of the transformer core portion for allowing a winding wire to wind around the bobbin base.

8. The power transformer of claim 1, wherein the first and second core portions each include an approximately half-cylinder shaped projection extending, within the interior space, from a first end surface of the first or second core portion to approximately a second end of the first or second core portion.

9. The power transformer of claim 1, wherein the bobbin base includes an approximately half-cylinder shaped top surface, an approximately half-ring shaped side surface at each of the bobbin base, and an approximately flat bottom surface.

10. The power transformer of claim 9, wherein the top surface and the bottom surface of the bobbin base define a hollow interior with openings formed at opposite ends of the bobbin base.

11. The power transformer of claim 10, wherein the openings allow the projection of the first and second core portions to slide into the hollow interior.

12. (canceled)
